(19) United States
(12) Patent Application Publication
(10) Pub. No.: US 2016/0017169 A1
(43) Pub. Date: Jan. 21, 2016

(54) UV-CURABLE COATING COMPOSITION

(71) Applicant: BAYER MATERIALSCIENCE AG, Deutschland (DE)

(72) Inventors: Serguei KOSTROMINE, Swisttal (DE); Frauke KÜHN, Leverkusen (DE)

(21) Appl. No.: 14/763,549

(22) PCT Filed: Jan. 30, 2014
(86) PCT No.: PCT/EP2014/051747

§ 371 Date: Jul. 27, 2015

(30) Foreign Application Priority Data
Feb. 1, 2013 (EP) 13153694.8
Feb. 1, 2013 (EP) 13153700.3
Feb. 1, 2013 (EP) 13153702.9
Feb. 1, 2013 (EP) 13153704.5
Apr. 24, 2013 (EP) 13165168.9
Apr. 24, 2013 (EP) 13165170.5
Jun. 17, 2013 (EP) 13172336.3

(51) Int. Cl. C09D 133/14; B05D 3/06

(52) U.S. Cl. CPC C09D 133/14; B05D 3/067

(57) ABSTRACT

The present invention relates to a coating composition comprising:
a) one or more aliphatic polymer precursors selected from components A.1 and optionally A.2:
   A.1) aliphatic oligomers containing urethane or ester bonds and having at least two acrylate functions per molecule, or mixtures of said oligomers, and
   A.2) aliphatic reactive diluents having at least two acrylate groups per molecule, or mixtures of said reactive diluents,
b) optionally one or more finely divided inorganic compounds,
c) an organic UV absorber,
d) optionally a free radical scavenger from the HALS class,
e) optionally one or more levelling additives,
f) optionally one or more solvents, and
g) a photoinitiator.

It further relates to a process for the coating of a substrate, to the coated substrates obtainable in this way, and to the use of the coated substrates.

UV absorbers C) are those of formulae (Ia) and (Ib):

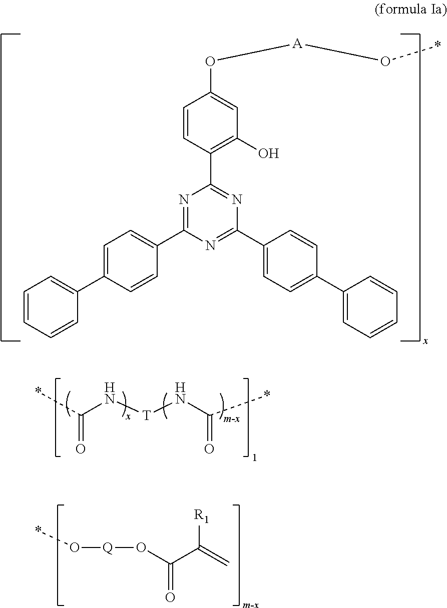

and

B—X—O—C(═O)—C(R)═CH₂ (formula Ib)

where

B is:

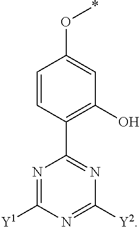

The present invention relates to a coating composition comprising:

A) one or more aliphatic polymer precursors selected from components A.1 and optionally A.2:
A.1) aliphatic oligomers containing urethane or ester bonds and having at least two acrylate functions per molecule, or mixtures of said oligomers, and
A.2) aliphatic reactive diluents having at least two acrylate groups per molecule, or mixtures of said reactive diluents,
   B) optionally one or more finely divided inorganic compounds,
   C) an organic UV absorber,
   D) a non-incorporable free radical scavenger from the HALS class,
   E) optionally one or more levelling additives,
   F) optionally one or more solvents, and
   G) a photoinitiator.

It further relates to a process for the coating of a substrate, to the coated substrates obtainable in this way, and to the use of the coated substrates.

Polycarbonate mouldings have been known for a long time. However, polycarbonate has the disadvantage that it is not itself inherently UV-stable. The sensitivity curve of bisphenol A polycarbonate exhibits the highest sensitivity between 320 nm and 330 nm.

A permanent coating on a UV-sensitive plastic substrate such as polycarbonate, i.e. a multilayer product that is also suitable for prolonged external use, additionally requires efficient UV protection in the protective layer.

Typical UV stabilizers known for use in coatings are UV absorbers such as 2-hydroxy-benzophenones, 2-(2-hydroxyphenyl)benzotriazoles, 2-(2-hydroxyphenyl)-1,3,5-triazines, 2-cyanoacrylates and oxalanilides, and free radical scavengers of the HALS (hindered amine light stabilizer) type. With a UV-curing binder, these additional coating components influence the free radical crosslinking reaction initiated by UV light, by competing with the photoinitiator for UV light or by trapping the initiator or secondary radicals formed.

The UV protection becomes weaker when the UV absorber diffuses out of the binder. Moreover, the mechanical properties and the stability to aggressive substances change when the binder network is disrupted, especially when large amounts of fillers or additives are used.

WO 2010/130349 A1 describes a multilayer structure in which the first layer consists of a UV-curing protective layer with silica nanoparticles, and the second layer is a thermoplastic substrate. The coating has a high abrasion resistance. Weathering data are not disclosed. Only unreactive UV absorbers, which cannot bind to the matrix, are used.

U.S. Pat. No. 5,189,084 describes o-hydroxyphenyl-s-triazines with functional groups for incorporation into a polymer. Triazines with biphenyl radicals are not mentioned.

WO 2011/040541 A1 describes an optical laminate comprising a light transmitting substrate and a scratch resistant coating on the light transmitting substrate.

WO 2011/006552 describes a process for the coating of, in particular, transparent polycarbonate substrates, wherein a transparent coating agent, comprising at least one radiation-curing binder (A) and/or reactive diluent (C), nanoparticles (B), optionally solvents and at least one light stabilizer (L), is applied to a polycarbonate substrate, characterized in that the coating agent comprises at least one light stabilizer (L) which contains per molecule, on average, at least one ethylenically unsaturated group bonded via a urethane group, and the coating agents. This document, especially the experimental section, teaches that a non-incorporable HALS system and dimethyltriazine as UV absorber have poorer properties in respect of haze and adhesion than an incorporable HALS and an incorporable UV absorber (Example 2 and Example 3). By contrast, the present invention shows that good haze and adhesion, and a good chemical resistance of the coating, are achieved even with a non-incorporable HALS and UV absorber. Thus, coatings with good haze, adhesion and chemical resistance can easily be achieved using commercially available types of HALS.

WO 2000/66675 describes a large number of UV absorbers including ones represented by formula (Ib), and their use in coating compositions. The combination of UV absorber and non-incorporable HALS is not explicitly described in this document. The scratch resistant layer is produced by using ultraviolet light to cure a composition for a scratch resistant layer that comprises a polyfunctional UV-curable (meth)acrylic acid binder, a UV absorber and a photopolymerization initiator. Various hydroxyphenylbenzotriazoles and triazines and their copolymers with (meth)acrylates are described as UV absorbers. UV absorbers containing a (meth)acrylate group are used for copolymerization in order to increase the molecular weight of the molecule. There is no chemical bond between the UV absorber and the coating matrix. The curing energies used are very small (in the region of 250 mJ/cm²), which leads to a hardness gradient in the coating layer and a gradient in the degree of polymerization along the thickness of the layer. This is in contrast to the systems described in this patent application, which are cured with markedly higher energy so as to achieve a complete curing throughout the entire thickness of the layer.

U.S. Pat. No. 6,191,199 describes an adhesive composition with various UV absorbers. Ones containing polymerizable groups are also mentioned, but the adhesive composition is a physical mixture of the components that cures without a chemical reaction between UV absorber and matrix.

U.S. Pat. No. 5,869,588 describes polymer components obtained by the homopolymerization of UV absorbers containing unsaturated groups or by the copolymerization of these UV absorbers with ethylenically unsaturated monomers.

Based on the state of the art, one object of the present invention was to provide a UV-curing coating composition for use on a UV-sensitive thermoplastic substrate, said composition having an improved weathering resistance and a good to improved scratch resistance, as well as a good chemical resistance, and exhibiting a high hardness in e.g. the pencil hardness test.

Moreover, the UV absorber should not migrate out of the coating in the presence of moisture and heat.

In addition, the UV absorber should have a very good solubility or dispersibility in the component matrix, so that the parts obtained after coating are optically transparent.

This object is achieved according to the invention by a coating composition comprising:

A) one or more aliphatic polymer precursors selected from components A.1 and optionally A.2:
A.1) aliphatic oligomers containing urethane or ester bonds and having at least two acrylate functions per molecule, or mixtures of said oligomers, and
A.2) aliphatic reactive diluents having at least two acrylate groups per molecule, or mixtures of said reactive diluents,
   B) optionally one or more finely divided inorganic compounds,
   C) an organic UV absorber,
   D) a non-incorporable free radical scavenger from the HALS class,
   E) optionally one or more levelling additives,
   F) optionally one or more solvents, and
   G) a photoinitiator.

In the coating composition according to the invention the organic UV absorber C) is an absorber of general formula (Ia):

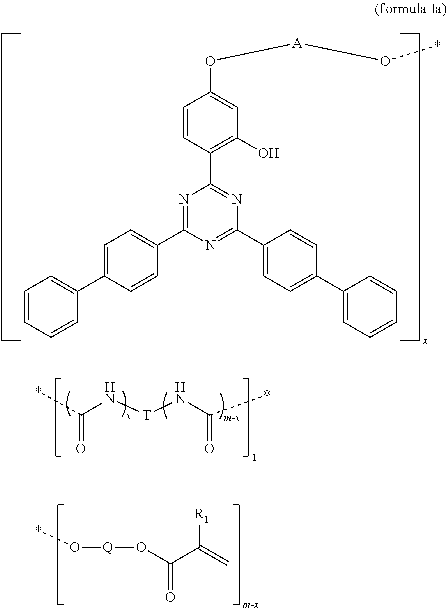

where
R is hydrogen or a methyl radical,
Q is a linear or branched alkylene having preferably 1 to 10 and particularly 2 to 6 carbon atoms, which is particularly preferably selected from the group comprising 2-hydroxyethyl (meth)acrylate, 2-hydroxypropyl(meth)acrylate, 4-hydroxybutyl (meth)acrylate and 3-hydroxy-2,2-dimethylpropyl(meth)acrylate,
T is a nucleus of the commercially available aliphatic and cycloaliphatic polyisocyanates T(NCO)ₘ which have cyclic isocyanurate, uretdione, iminooxadiazinedione or oxadiazinetrione structures, as well as branched biuret structures in the case of cycloaliphatic polyisocyanates,
m corresponds to the original average NCO functionality of the polyisocyanate used and is equal to or greater than 2,
A is an optionally substituted, linear or branched alkylene having preferably 1 to 20, particularly preferably 4 to 18 and especially 6 to 12 carbon atoms, it being possible for the carbon chain to be interrupted by oxygen, carboxyl, nitrogen, sulfur, phosphorus and/or silicon, preferably oxygen and/or carboxyl,
and
x represents the average molar proportion of the bound UV absorber radical and is less than m. Preferably, x is equal to or less than 1.

In terms of the average values of m and x, the invention also includes mixtures of one or more structures of formula (Ia) with structures of formulae (II) and (III):

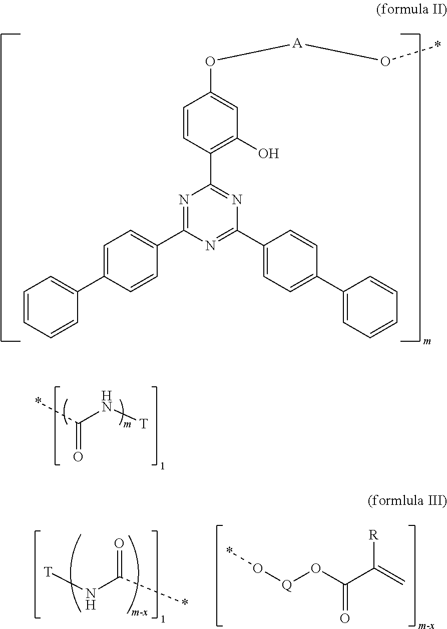

whose appearance in the process for the preparation of the products of formula (Ia) cannot be excluded.

The compounds of formula (Ia) according to the invention preferably have a UV absorption maximum between 300 and 340 nm.

Preferably, A in the compounds of general formula (Ia) is an optionally substituted, linear or branched linker, there being in the chain, between the O atom of the aromatic nucleus of the UV absorber and the O atom of the urethane group, a chain of at least 4 atoms selected from carbon, oxygen, nitrogen, sulfur, phosphorus and/or silicon.

or a UV absorber of general formula (Ib):

B—X—O—C(═O)—C(R)═CH₂ (Ib)

where

### B is:

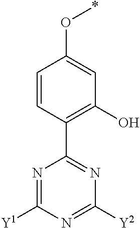

Y¹ and Y² independently of one another are substituents of the general formula

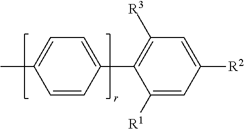

r is 0 or 1, preferably 1,
R¹, R², R³ independently of one another are H, OH, C₁₋₂₀-alkyl, C₄₋₁₂-cycloalkyl, C₂₋₂₀-alkenyl, C₁₋₂₀-alkoxy, C₄₋₁₂-cycloalkoxy, C₂₋₂₀-alkenyloxy, C₇₋₂₀-aralkyl, halogen, —C≡N, C₁₋₅-halogenoalkyl, —SO₂R′, —SO₃H, —SO₃M (M=alkali metal), —COOR′, —CONHR′, —CONR′R″, —OCOOR′, —OCOR′, —OCONHR′, (meth)acrylamino, (meth)acryloxy, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
M is an alkali metal cation,
R′ and R″ are H, C₁₋₂₀-alkyl, C₄₋₁₂-cycloalkyl, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
X is branched or unbranched C₁₋₂₀-alkyl, and

### R is H or CH₃.

### Components for the Preparation of the Composition

### Component A

Polymer precursors suitable as component A having at least two acrylate groups per molecule are preferably those of the formula

(R¹₂C═CR²CO₂)ₙR³

where
n≧2,
R¹ and R² independently of one another are H or C₁- to C₃₀-alkyl, preferably H, methyl or ethyl, and
R³ in the case of polymer precursors suitable as component A.1 is an n-valent organic radical consisting of aliphatic hydrocarbon units linked via urethane or ester bonds, or
R³ in the case of polymer precursors suitable as component A.2 is an n-valent organic radical preferably having 1-30 carbon atoms.

The preparation of the oligomers suitable as component A.1 which belong to the class of the aliphatic urethane acrylates or the polyester acrylates, and their use as coating binders, are known and are described in Chemistry & Technology of UV & EB Formulation for Coatings, Inks & Paints, Vol. 2, 1991, SITA Technology, London (P. K. T. Oldring (Ed.)) on pp 73-123 (Urethane Acrylates) or pp 123-135 (Polyester Acrylates).

The following examples are commercially available and suitable in terms of the invention: aliphatic urethane acrylates such as Ebecryl® 4858, Ebecryl® 284, Ebecryl® 265 and Ebecryl® 264 (all manufactured by Cytec Surface Specialities), Craynor® 925 from Cray Valley, Viaktin® 6160 from Vianova Resin, Desmolux® U 100 from Bayer MaterialScience AG, Photomer® 6891 from Cognis, or aliphatic urethane acrylates dissolved in reactive diluents, such as Laromer® 8987 (70% in hexanediol-diacrylate) from BASF AG, Desmolux® U 680 H (80% in hexanediol diacrylate) from Bayer MaterialScience AG, Craynor® 945B85 (85% in hexanediol diacrylate) and Craynor® 963B80 (80% in hexanediol diacrylate), both from Cray Valley, or polyester acrylates such as Ebecryl® 810 or 830 from Cytec Surface Specialities.

The preparation and use of reactive diluents suitable as component A.2 are known and are described in Chemistry & Technology of UV & EB Formulation for Coatings, Inks & Paints, Vol. 2, 1991, SITA Technology, London (P. K. T. Oldring (Ed.)) on pp 237-306 (Reactive Diluents). The following examples are suitable in terms of the invention: methanediol diacrylate, 1,2-ethanediol diacrylate, 1,3-propanediol diacrylate, 1,2-propanediol diacrylate, glycerol triacrylate, 1,4-butanediol diacrylate, 1,3-butanediol diacrylate, 1,2,4-butanetriol triacrylate, 1,5-pentanediol diacrylate, neopentyl glycol diacrylate, pentaerythritol triacrylate, pentaerythritol tetraacrylate, 1,6-hexandiol diacrylate, trimethylolpropane diacrylate, trimethylolpropane triacrylate, tricyclodecane-dimethanol diacrylate, diethylene glycol diacrylate, triethylene glycol diacrylate, tetraethylene glycol diacrylate, dipropylene glycol diacrylate, tripropylene glycol diacrylate, trimethylolpropane triethoxytriacrylate, dipentaerythritol pentaacrylate, dipentaerythritol hexaacrylate, ditrimethylolpropane tetraacrylate and the corresponding methacrylate derivatives. It is preferable to use 1,6-hexanediol diacrylate, tricyclodecanedimethanol diacrylate, trimethylolpropane triacrylate, pentaerythritol tetraacrylate and their methacrylate derivatives. It is particularly preferable to use 1,6-hexanediol diacrylate, tricyclodecanedimethanol diacrylate and their methacrylate derivatives, especially in a mixture with component A.1.

In another embodiment of the coating composition according to the invention, component A.1 comprises an unsaturated aliphatic urethane acrylate (preferably dissolved in reactive diluent), particularly preferably an unsaturated aliphatic urethane triacrylate.

### Component B

Component B consists of finely divided inorganic compounds that preferably consist of at least one polar compound of one or more metals of main group 1 to 5 or subgroup 1 to 8 of the Periodic Table, preferably main group 2 to 5 or subgroup 4 to 8 and particularly preferably main group 3 to 5 or subgroup 4 to 8, or of compounds of these metals with at least one element selected from oxygen, hydrogen, sulfur, phosphorus, boron, carbon, nitrogen and silicon.

Examples of preferred compounds are oxides, hydroxides, hydrated oxides, sulfates, sulfites, sulfides, carbonates, carbides, nitrates, nitrites, nitrides, borates, silicates, phosphates, hydrides, phosphites or phosphonates.

Preferably, the finely divided inorganic compounds consist of oxides, phosphates and hydroxides, preference being afforded to TiO₂, SiO₂, SnO₂, ZnO, ZnS, ZrO₂, Al₂O₃, AlO(OH), boehmite, aluminium phosphates and also TiN, WC, Fe₂O₃, iron oxides, NaSO₄, vanadium oxides, zinc borate, and silicates such as Al silicates, Mg silicates and one-, two- and three-dimensional silicates. Mixtures and doped compounds can likewise be used.

Hydrated aluminium oxides (e.g. boehmite) and silicon dioxide are particularly preferred. Silicon dioxide is very particularly preferred.

In terms of the invention, the finely divided inorganic compounds have a mean particle size (d₅₀ value) of 1 to 200 nm, preferably 5 to 50 nm and particularly preferably 7-40 nm. In particular, the finely divided inorganic compounds have a narrow particle size distribution with a (d₉₀-d₁₀)/d₅₀ value less than or equal to 2, particularly preferably of 0.2 to 1.0. The particle size is determined by analytical ultracentrifugation, d₉₀ being the 90% value, d₁₀ the 10% value and d₅₀ the mean value of the integral mass distribution of particle size. The use of analytical ultracentrifugation for particle size determination is described in H. G. Müller, Progr. Colloid Polym. Sci. 2004, 127, pages 9-13.

The surface of these finely divided inorganic compounds can be modified with alkoxysilane or alkylsilane compounds.

In one preferred embodiment, the finely divided inorganic compound is used as a dispersion in at least one component selected from the group comprising A) and F). Preference is afforded to finely divided inorganic compounds which are dispersible in the coating formulation without forming agglomerates.

### Component C

The UV absorbers of component C are discussed further in the context of preferred embodiments. It can generally be observed that, in the case of photochemical curing of the coating composition, the UV absorber is incorporated into the polymer matrix.

In one embodiment of the coating composition according to the invention, T in formula (Ia) for the UV absorber C) is preferably an isocyanurate based on hexamethylene diisocyanate (HDI).

In another embodiment of the coating composition according to the invention, Q in formula (Ia) for the UV absorber C) is preferably CH₂—CH₂ (ethylene).

In another embodiment of the coating composition according to the invention, A in formula (Ia) for the UV absorber C) is preferably C(CH₃)—CO—O—CH₂—CR⁴R⁵—CH₂, R⁴ and R⁵ independently of one another being alkyl having 1 to 6 carbon atoms, preferably methyl and/or ethyl.

In one embodiment of the coating composition according to the invention, X in formula (Ib) for the UV absorber C) is CH(CH₃).

In another embodiment of the coating composition according to the invention, r in the substituents Y¹ and Y² in formula (Ib) for the UV absorber C) is in each case 1.

In another embodiment of the coating composition according to the invention, the radicals R¹, R² and R³ in the substituents Y¹ and Y² in formula (Ib) for the UV absorber C) are in each case H.

Preferably, the UV absorber C) of formula (Ib) is selected from the following compounds:

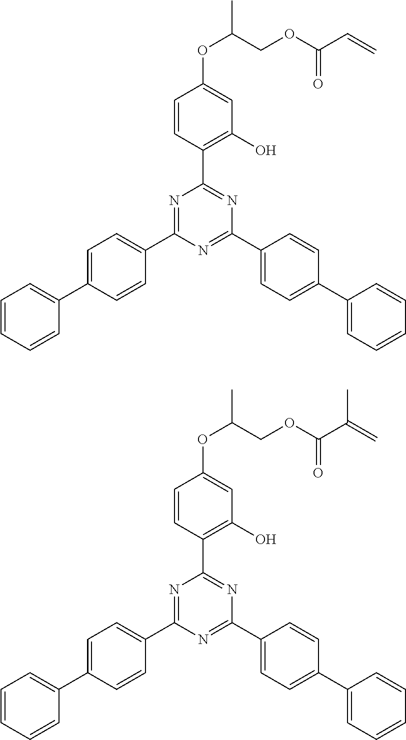 [SMILES: C=CC(=O)OCC(C)Oc1ccc(-c2nc(-c3ccc(-c4ccccc4)cc3)nc(-c3ccc(-c4ccccc4)cc3)n2)c(O)c1 ; C=C(C)C(=O)OCC(C)Oc1ccc(-c2nc(-c3ccc(-c4ccccc4)cc3)nc(-c3ccc(-c4ccccc4)cc3)n2)c(O)c1]

These compounds can be obtained e.g. from commercially available precursors such as Tinuvin® 479 (cf. below) by transesterification with (meth)acrylic acid.

UV absorbers of formula (Ia) containing urethane acrylate can be prepared e.g. as follows:

a) reaction of a compound of the general formula

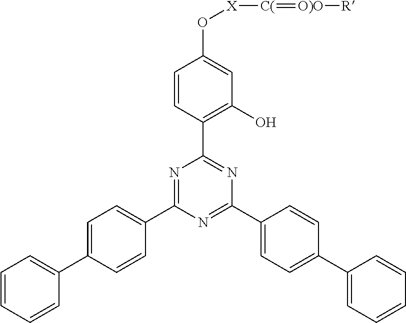

where X is branched or unbranched C₁₋₂₀-alkyl and R′ is branched or unbranched C₁₋₂₀-alkyl, C₄₋₁₂-cycloalkyl, or C₆₋₁₂-aryl optionally substituted by C₁₋₁₂-alkyl, C₁₋₁₂-alkoxy, CN and/or halogen,
with an at least difunctional alcohol; and
b) reaction of the product obtained in step a) with
bi) an aliphatic or cycloaliphatic urethane acrylate containing isocyanate groups which has cyclic isocyanurate, uretdione, iminooxadiazinedione or oxadiazinetrione structures or, in the case of a cycloaliphatic urethane acrylate, can also have branched biuret structures,
and/or with
bii) an aliphatic or cycloaliphatic polyisocyanate containing isocyanate groups which has cyclic isocyanurate, uretdione, iminooxadiazinedione or oxadiazinetrione structures or, in the case of a cycloaliphatic polyisocyanate, can also have branched biuret structures,
the reaction in step b) further taking place in the presence of a hydroxyalkyl(meth)acrylate and/or the product obtained after the reaction in step b) being reacted further with a hydroxyalkyl(meth)acrylate.

In the process according to the invention, it is possible e.g. for a polyisocyanate T(NCO)ₘ to be reacted with the substance of formula (IV) dissolved in a suitable solvent:

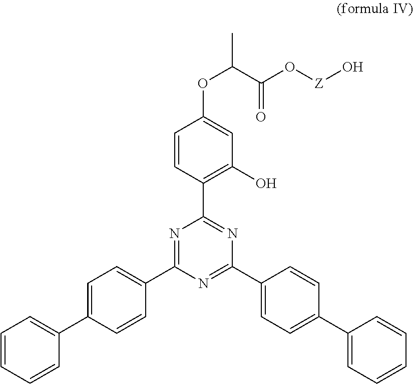

(Z=C₁- to C₁₈-alkylene, preferably C₁- to C₁₂-alkylene, e.g. methylene, ethylene, propylene or octylene).

This reaction is continued until all of the substance of formula (IV) is bonded to polyisocyanate via resulting urethane groups. Hydroxyalkyl(meth)acrylate is then added to the resin in order to allow all the remaining NCO groups of the polyisocyanate to react with OH groups of the hydroxyalkyl(meth)acrylate. When this reaction has ended, the appropriate solvent is added to bring the viscosity of the resin to a desired level.

According to US 2012/0094127 A1, the UV absorbers of the s-triazine class (formula IV), functionalized with an OH group, are prepared by the direct transesterification of Tinuvin 479® (BASF product) with a diol HO—Z—OH.

Another embodiment of the preparative process consists in using the NCO-containing urethane acrylates (formula V):

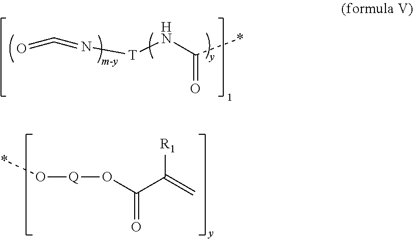

instead of the polyisocyanates T(NCO)ₘ. Examples of such products are the NCO-containing urethane acrylates Desmolux® D100, VP LS 2396 and XP 2510 from Bayer MaterialScience. The process then continues as described above.

The substance of formula IV is introduced into the reaction with polyisocyanate in a form that is liquid under the reaction conditions. Three variants are considered:
The substance of formula IV is added to the polyisocyanate in the form of a solution in another reagent of the process, such as hydroxyalkyl(meth)acrylate. The remainder of the hydroxyalkyl(meth)acrylate is added later in a second step of the reaction.
The substance of formula IV is added to the polyisocyanate in the form of a solution in NCO-neutral solvent. In this case the whole of the hydroxyalkyl(meth)acrylate is reacted later as a second step. The fact that, according to the invention, the reaction of NCO group with OH group proceeds without a catalyst allows tertiary alcohols, e.g. diacetone alcohol, to be used as solvents (particularly advantageously) for this synthesis.
The substance of formula IV reacts in the form of a melt with the polyisocyanate. In this case the whole of the hydroxyalkyl(meth)acrylate is reacted later as a second step.

### Component D

Component D in terms of the invention is a so-called HALS (hindered amine light stabilizer) system. The HALS system according to the present invention is a sterically hindered amine compound; such compounds are generally liquid or solid piperidine derivatives having the general structure of formula (IV):

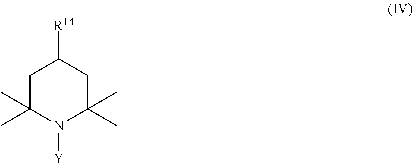

where

### Y=H or CH₃,

### R¹⁴=Z—R¹⁵—Z—R¹⁶,

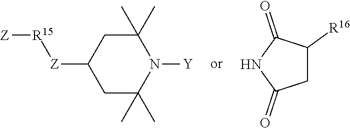

Z=a divalent functional group, e.g. preferably C(O)O, NH or NHCO,
R¹⁵=a divalent organic radical, e.g. preferably (CH₂)ₗ, where l=1 to 12, preferably 3 to 10, C═CH-Ph-OCH₃,

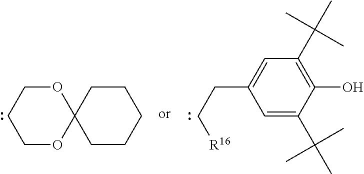

and
R¹⁶ is H or C₁-C₂₀-alkyl.

Sterically hindered amines act as free radical scavengers that trap radicals formed in the polymer degradation. They are non-incorporable, i.e. they do not contain reactive groups capable of reacting with component A. A general survey of different types of HALS is given in T. Bolle: Lackadditive, J. Bielemann (Ed.), Wiley-VCH, Weinheim (1998), and in A. Valet: Lichtschutzmittel für Lacke, Vincentz Verlag, Hannover (1996). Preferred HALS can be found in EP 1308084 A and DE 60307122 A.

### Component E

Component E in terms of the invention is preferably any levelling additive that affords both a good wetting of the coating formulation on the surface of the second layer, and a visually attractive surface of the first layer formed when the coating formulation cures. A survey of common levelling additives is given in Janos Hajas: “Levelling Additives” in Additives for Coatings, Johan Bielemann (Ed.), Wiley-VCH Verlag GmbH, Weinheim 2000, pp 164-179. Levelling additives which can be used are surface-active compounds such as polydimethylsiloxanes. For example, it is preferable to use the levelling additive BYK® 300 (silicone-based surface additive from BYK Chemie GmbH).

### Component F

Component F in terms of the invention is a solvent or solvent mixture which has to be compatible with the second layer, and has to allow dispersion, application and airing of the coating formulation, to the extent that a multilayer product of high transparency and low haze is obtained after UV curing of the coating formulation to produce the actual protective layer. Preferred examples of possible solvents are alkanes, alcohols, esters, ketones or mixtures thereof. It is particularly preferable to use alcohols (with the exception of methanol), ethyl acetate and butanone. Very particularly preferred solvents or solvent mixtures are selected from at least one of the group comprising diacetone alcohol [(CH₃)₂C(OH)CH₂C(═O)CH₃], ethyl acetate, methoxypropanol and butanone.

### Component G

The composition comprises curing initiators. UV initiators (photoinitiators) are preferred.

Suitable UV initiators preferably have a high photochemical reactivity and an absorption band in the near UV range (>300 nm and preferably >350 nm).

Suitable photoinitiators are preferably selected from the group comprising acylphosphine oxide derivatives and α-aminoalkylphenone derivatives.

Suitable photoinitiators are preferably bis(2,4,6-trimethylbenzoyl)phenylphosphine oxide (Irgacure® 819 from Ciba Specialty Chemicals), (2,4,6-trimethylbenzoyl)diphenylphosphine oxide (Lucirin® TPO Solid from BASF AG), bis(2,6-dimethylbenzoyl)(2,4,4-trimethylpentyl)phosphine oxide, bis(2,6-dimethoxybenzoyl)(2,4,4-trimethylpentyl)phosphine oxide, benzoylphosphonic acid bis(2,6-dimethylphenyl) ester (Lucirin® 8728 from BASF AG), ethyl 2,4,6-trimethylbenzoylphenylphosphinate (Lucirin® TPO-L from BASF AG), 2-benzyl-2-(dimethylamino)-1-(4-morpholino-phenyl)-1-butanone (Irgacure® 369 from Ciba Specialty Chemicals) and 2-methyl-1-[4-(methylthio)phenyl]-2-morpholino-1-propanone (Irgacure® 907 from Ciba Specialty Chemicals).

Bis(2,4,6-trimethylbenzoyl)phenylphosphine oxide (Irgacure® 819 from Ciba Specialty Chemicals), ethyl 2,4,6-trimethylbenzoylphenylphosphinate (Lucirin® TPO-L from BASF AG) and 2-methyl-1-[4-(methylthio)phenyl]-2-morpholino-1-propanone (Irgacure® 907 from Ciba Specialty Chemicals) are particularly preferred.

It is also possible to use mixtures of these photoinitiators with other known photoinitiators, e.g. α-hydroxyalkylphenone or phenylacetophenone. Preference is afforded to mixtures of bis(2,6-dimethoxybenzoyl)(2,4,4-trimethylpentyl)phosphine oxide and (1-hydroxycyclohexyl)phenyl-methanone, particularly preferably in the ratio 25:75 (Irgacure® 1800 from Ciba Specialty Chemicals), mixtures of 2,4,6-trimethylbenzoyldiphenylphosphine oxide and 2-hydroxy-2-methyl-1-phenyl-1-propanone, preferably in the ratio 50:50 (Darocur 4265 from Ciba Specialty Chemicals), mixtures of 1-hydroxycyclohexyl phenyl ketone (Irgacure® 184 from Ciba Specialty Chemicals) and 2,4,6-trimethylbenzoylethoxyphenylphosphine oxide (Lucirin® TPO-L from BASF AG) in the ratio 80:20, or a mixture of bis(2,6-dimethoxybenzoyl)(2,4,4-trimethylpentyl)phosphine oxide and 2-hydroxy-2-methyl-1-phenyl-1-propanone, particularly preferably in the ratio 25:75 (Irgacure® 1700 from Ciba Specialty Chemicals).

Embodiments and further features of the invention are illustrated below. They can be freely combined with one another, provided this is not clearly contradicted by the context.

For example, it is possible to use the following, based on the mixture of components A and B:

20 to 95 wt %, preferably 50 to 80 wt/o and particularly preferably 67 to 72 wt % of component A,

5 to 80 wt %, preferably 20 to 50 and particularly preferably 28 to 33 wt % of component B, and

0.1 to 15 wt %, preferably 0.5 to 10 wt %/o and particularly preferably 3 to 6 wt % of component C.

The amount of solvent (component F) is measured so that the resulting experimentally determined solids content of the mixture of components A, B and F is 20 to 50 wt %, preferably 30-40 wt %.

The following are used, based on the solids content of the mixture of components A and B:

0.1 to 10, preferably 2 to 8 and particularly preferably 3 to 5 wt % of component G, and

0 to 5, preferably 0.5 to 3 wt % and particularly preferably 1 to 2 wt %/o of component E.

The present invention also provides a process for the coating of a substrate, comprising the following steps:
application of a coating composition according to the invention to a substrate;
curing of the previously applied coating composition by irradiation with UV light in a dose of at least 2 J/cm².

Preferably, in the first step, the composition is applied to the substrate surface by flow coating, dipping, spraying, calender coating or spin coating and then aired at room temperature and/or elevated temperature (preferably at 20-200° C., particularly preferably at 40-120° C.). The substrate surface can be pretreated by cleaning or activation.

Preferably, in the second step (ii), the protective layer is cured by means of UV light, the UV light source used preferably being an iron-doped mercury vapour lamp or else a pure or gallium-doped mercury vapour lamp. Said layer is thus irradiated with light whose maximum intensity is at a wavelength of 254 nm.

A dose of at least 2 J/cm², according to the invention, ensures thorough curing of the entire layer of coating agent and incorporation of the UV absorber into the polymer matrix formed. A preferred dose is in the range from 3 to 6 J/cm². The UV dose can be determined with a UV-4C SD measuring instrument from UV-Technik Meyer GmbH, the dose being the sum of the incident energy in the range 230-445 nm.

In one embodiment of the process according to the invention, the substrate is a thermoplastic substrate.

In another embodiment of the process according to the invention, the substrate is a polycarbonate substrate.

### Substrates

Thermoplastic polymers of the substrate in terms of the invention are polycarbonate, polyester carbonate, polyester (e.g. polyalkylene terephthalate), polymethyl methacrylate, polyphenylene ether, graft copolymers (e.g. ABS) and mixtures thereof.

The second layer is preferably polycarbonate, especially homopolycarbonate, copolycarbonate and/or thermoplastic polyester carbonate.

They preferably have mean molecular weights M_{w} of 18,000 to 40,000, preferably 22,000 to 36,000 and especially 24,000 to 33,000, determined by measuring the relative solution viscosity in dichloromethane or in mixtures of equal amounts by weight of phenol/o-dichlorobenzene, calibrated by light scattering.

. . . stabilizers, heat stabilizers, antistatic agents and pigments can be added in the conventional amounts to the polycarbonates according to the invention and to any other . . . present; if appropriate, the demoulding behaviour and/or the flow behaviour can also be improved by adding external demoulding agents and/or flow control agents (e.g. alkyl and aryl phosphites, phosphates and phosphanes, low-molecular carboxylic acid esters, halogen compounds, salts, chalk, quartz flour, glass and carbon fibres, pigments and a combination thereof). Such compounds are described e.g. in WO 99/55772, pp 15-25, EP 1 308 084 and the appropriate chapters of “Plastics Additives Handbook”, ed. Hans Zweifel, 5^{th} Edition 2000, Hanser Publishers, Munich.

For the preparation of polycarbonates, reference may be made e.g. to WO 2004/063249 A1, WO 2001/05866 A1, WO 2000/105867, U.S. Pat. No. 5,340,905, U.S. Pat. No. 5,097,002, U.S. Pat. No. 5,717,057 and the literature cited therein.

The preparation of polycarbonates is preferably carried out by the phase boundary process or the melt transesterification process and is described below using the phase boundary process by way of example.

Compounds that are preferably to be used as starting compounds are bisphenols of general formula (V):

HO—R—OH (V)

where R is a divalent organic radical having 6 to 30 carbon atoms and containing one or more aromatic groups.

Examples of such compounds are bisphenols belonging to the group comprising dihydroxybiphenyls, bis(hydroxyphenyl)alkanes, indane bisphenols, bis(hydroxyphenyl) ethers, bis(hydroxyphenyl) sulfones, bis(hydroxyphenyl) ketones and α,α′-bis(hydroxyphenyl)diisopropylbenzenes.

Particularly preferred bisphenols belonging to the aforementioned groups of compounds are bisphenol A, tetraalkylbisphenol A, 4,4-(metaphenylenediisopropyl)diphenol (bisphenol M), 4,4-(paraphenylenediisopropyl)diphenol, 1,1-bis(4-hydroxyphenyl)-3,3,5-trimethylcyclohexane (BP-TMC) and optionally mixtures thereof.

Preferably, the bisphenol compounds to be used according to the invention are reacted with carbonic acid compounds, especially phosgene, or, in the case of the melt transesterification process, with diphenyl carbonate or dimethyl carbonate.

Polyester carbonates are preferably obtained by reacting the bisphenols already mentioned, at least one aromatic dicarboxylic acid and optionally carbonic acid equivalents. Examples of suitable aromatic dicarboxylic acids are phthalic acid, terephthalic acid, isophthalic acid, 3,3′- or 4,4′-diphenyldi-carboxylic acid and benzophenonedicarboxylic acids. A proportion of up to 80 mol %, preferably of 20 to 50 mol %, of the carbonate groups in the polycarbonates can be replaced with aromatic dicarboxylic acid ester groups.

Examples of inert organic solvents used in the phase boundary process are dichloromethane, the various dichloroethanes and chloropropane compounds, carbon tetrachloride, chloroform, chlorobenzene and chlorotoluene, it being preferable to use chlorobenzene, dichloromethane or mixtures of dichloromethane and chlorobenzene.

The phase boundary reaction can be accelerated by catalysts such as tertiary amines, especially N-alkylpiperidines or onium salts. It is preferable to use tributylamine, triethylamine and N-ethyl-piperidine. In the case of the melt transesterification process, it is preferable to use the catalysts mentioned in DE-A 4 238 123.

The polycarbonates can be intentionally branched in controlled manner by the use of small amounts of branching agents. Some suitable branching agents are phloroglucinol, 4,6-dimethyl-2,4,6-tri(4-hydroxyphenyl)-2-heptene, 4,6-dimethyl-2,4,6-tri(4-hydroxyphenyl)heptane, 1,3,5-tri(4-hydroxy-phenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, hexa(4-(4-hydroxyphenylisopropyl)phenyl)orthoterephthalic acid ester, tetra(4-hydroxy-phenyl)methane, tetra(4-(4-hydroxyphenylisopropyl)phenoxy)methane, α,α′,α″-tris(4-hydroxyphenyl)-1,3,5-triisopropylbenzene, 2,4-dihydroxybenzoic acid, trimesic acid, cyanuric chloride, 3,3-bis(3-methyl-4-hydroxyphenyl)-2-oxo-2,3-dihydroindole and 1,4-bis(4′,4″-dihydroxytriphenyl-methyl)benzene, especially 1,1,1-tri(4-hydroxyphenyl)ethane and bis(3-methyl-4-hydroxyphenyl)-2-oxo-2,3-dihydroindole.

The amount of 0.05 to 2 mol % (based on diphenols used) of branching agents or mixtures thereof which is optionally to be used concomitantly can be introduced together with the diphenols or added at a later stage of the synthesis.

The chain terminators used are preferably phenols such as phenol, alkylphenols such as cresol and 4-tert-butylphenol, chlorophenol, bromophenol, cumylphenol or mixtures thereof, in amounts of 1-20 mol %, preferably 2-10 mol %, per mol of bisphenol. Phenol, 4-tert-butylphenol and cumylphenol are preferred.

The chain terminators and branching agents can be introduced into the syntheses separately or together with the bisphenol.

The preparation of the polycarbonates by the melt transesterification process is described by way of example in DE-A 4 238 123.

Polycarbonates which are preferred according to the invention for the second layer of the multilayer product according to the invention are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

The homopolycarbonate based on bisphenol A is particularly preferred.

The polycarbonate can comprise stabilizers. Examples of suitable stabilizers are phosphines, phosphites or Si-containing stabilizers and other compounds described in EP-A 0 500 496. Examples which may be mentioned are triphenyl phosphites, diphenyl alkyl phosphites, phenyl dialkyl-phosphites, tris(nonylphenyl) phosphite, tetrakis(2,4-ditert-butylphenyl)-4,4′-biphenylene diphosphonite and triaryl phosphite. Triphenylphosphine and tris(2,4-ditert-butylphenyl) phosphite are particularly preferred.

The polycarbonate-containing substrate of the multilayer product according to the invention can also comprise 0.01 to 0.5 wt % of esters or partial esters of monohydric to hexahydric alcohols, especially glycerol, pentaerythritol or guerbet alcohols.

Examples of monohydric alcohols are stearyl alcohol, palmityl alcohol and guerbet alcohols.

An example of a dihydric alcohol is glycol.

An example of a trihydric alcohol is glycerol.

Examples of tetrahydric alcohols are pentaerythritol and mesoerythritol.

Examples of pentahydric alcohols are arabitol, ribitol and xylitol.

Examples of hexahydric alcohols are mannitol, glucitol (sorbitol) and dulcitol.

The esters are preferably the monoesters, diesters, triesters, tetraesters, pentaesters and hexaesters or mixtures thereof, especially random mixtures, of saturated aliphatic C₁₀- to C₃₆-monocarboxylic acids and optionally hydroxymonocarboxylic acids, preferably saturated aliphatic C₁₄- to C₃₂-monocarboxylic acids and optionally hydroxymonocarboxylic acids.

The commercially available fatty acid esters, especially of pentaerythritol and glycerol, can contain <60% of different partial esters as a condition of the manufacturing process.

Examples of saturated aliphatic monocarboxylic acids having 10 to 36 C atoms are capric acid, lauric acid, myristic acid, palmitic acid, stearic acid, hydroxystearic acid, arachidic acid, behenic acid, lignoceric acid, cerotic acid and montanic acids.

Examples of preferred saturated aliphatic monocarboxylic acids having 14 to 22 C atoms are myristic acid, palmitic acid, stearic acid, hydroxystearic acid, arachidic acid and behenic acid.

Saturated aliphatic monocarboxylic acids such as palmitic acid, stearic acid and hydroxystearic acid are particularly preferred.

The saturated aliphatic C₁₀- to C₃₆-carboxylic acids and the fatty acid esters as such are either known in the literature or can be prepared by processes known in the literature. Examples of pentaerythritol fatty acid esters are those of the particularly preferred monocarboxylic acids mentioned above. Esters of pentaerythritol and glycerol with stearic acid and palmitic acid are particularly preferred. Esters of guerbet alcohols and glycerol with stearic acid and palmitic acid and optionally hydroxystearic acid are also particularly preferred.

The invention further relates to a multilayer structure comprising the substrate A and a protective layer B produced by curing the composition according to the invention. Other layers are optionally possible, either on the cured composition or on the substrate before the composition according to the invention is applied. Other layers are likewise possible with a layer sequence B-A-B, it being possible for the layers B to be identical or different according to the composition described.

The multilayer products according to the invention, or the thermoplastic polymers used for their preparation, can comprise organic dyestuffs, inorganic coloured pigments, fluorescent dyestuffs and, particularly preferably, optical brighteners.

The invention also provides the production of the coated products and the products built up from the multilayer products. The present invention likewise provides the use of said multilayer products particularly for external applications that have permanently high specifications in respect of visual impression, e.g. glazing.

In particular, the invention also provides multilayer products comprising a plastic moulding as substrate, said moulding preferably being produced from thermoplastic polymer by injection moulding or extrusion, and coated with the composition according to the invention and optionally also with other layers. For example, this multilayer product is glazing such as architectural glazing, automotive glazing, headlamp lenses, spectacle lenses or helmet visors.

Specifically, the invention further relates to a coated substrate comprising a substrate and a coating arranged on or above the substrate, the coating comprising a coating composition according to the present invention. Preferably, the substrate is a thermoplastic substrate, particularly preferably a polycarbonate substrate.

The invention further relates to a coated substrate comprising a substrate and a coating arranged on or above the substrate, the coating comprising a coating composition according to the invention which has been cured by irradiation with UV light in a dose of at least 2 J/cm². Preferably, the substrate is a thermoplastic substrate, particularly preferably a polycarbonate substrate.

Finally, the invention further relates to a product comprising a coated substrate according to the invention, the object being selected from the group comprising architectural glazing, automotive glazing, cover discs, helmet visors, housings for electrical appliances, window profiles, bodywork components and machine covers.

### EXAMPLES

The present invention is described in greater detail by means of the Examples below, without implying a limitation.

### Experimental Procedure

### General Description

### a) Preparation of the Composition

The amounts of components A and B indicated in Table A were mixed.

Components C and D were dissolved in about half the indicated amount of component F and added to the composition. Component G was completely dissolved in the remainder of component F and added to the formulation. Component E was added, with stirring. The solution was stirred until it was completely homogeneous.

### b) Coating of the Substrates with the UV-Curing Coating Formulation

The polycarbonate (PC) sheets used were GP U099 sheets (Bayer MaterialScience GmbH) of dimensions 10×15×0.32 cm. They were rinsed with isopropanol, aired and UV-pretreated (using an IST-UV Minicure laboratory UV radiator from IST Metz with a UV dose (Hg lamp) of 1.3 J/cm², measured with a UV-4C SD dosimeter from UV-Technik Meyer GmbH as the sum of the dose in the wavelength range from 230 nm to 445 nm). The UV-curing coating formulation from a) was then applied by the flow coating process. The coated sheets were aired for 10 min at room temperature and then dried at 70° C. for 10 min. They were then cured using an IST-UV Minicure laboratory UV radiator from IST Metz with a UV dose (Hg lamp) between 4 and 6 J/cm², measured with a UV-4C SD dosimeter from UV-Technik Meyer GmbH as the sum of the dose in the wavelength range from 230 nm to 445 nm.

### c) Testing of the Adhesion of the UV-Curing Protective Layer to the PC Substrate

The following adhesion tests were performed:

(a) adhesive tape pull-off (adhesive tape used: 3M Scotch 898) with cross-cut (analogously to ISO 2409 or ASTM D 3359), and
(b) adhesive tape pull-off after storage for 1, 2, 3 and 4 hours in boiling water (analogously to ISO 2812-2 and ASTM 870-02).

All the Examples recorded here exhibited full adhesion after both (a) and (b) (ISO index: 0 or ASTM index: 5B).

### d) Measurement of the Abrasion Resistance and Determination of the Taber Wear Index

Firstly the initial haze of the PC sheet coated with the UV-cured first layer (obtained from c)) was determined according to ASTM D 1003 with a Haze Gard Plus from Byk-Gardner. Then the coated side of the sample was scratched with a model 5131 Taber Abraser from Erichsen according to ISO 52347 or ASTM D 1044 using the CS10F wheels (type IV; grey). A Δhaze (sample) could be measured by determining the final haze after 1000 cycles with a load of 500 g.

In terms of the invention, the protective layer should have a sufficiently high scratch resistance. This criterion is achieved in terms of the invention when the Taber index (Δhaze after 1000 cycles) is less than or equal to 6.0%.

### e) Measurement of the Resistance to Acetone

The samples were placed horizontally on a laboratory bench at room temperature (e.g. 23° C.). A wad of cotton wool impregnated with acetone was laid on the sample and covered with a watch glass to prevent evaporation of the solvent. After various exposure times (1 min, 5 min, 15 min, 30 min) the watch glass and the wad of cotton wool were removed. The surface of the sample was carefully dried with a soft cloth. The surface was assessed visually. In the absence of visible damage, the result is given a plus notation; in the presence of visible damage, the result is given a minus notation. In terms of the invention, the protective layer should have a sufficiently high resistance to acetone. This criterion is achieved in terms of the invention when there is no visible damage (corresponding to a plus notation) after 30 min.

### f) Measurement of the Weathering Resistance

Accelerated weathering is carried out according to ASTM G155 mod in an Atlas Ci 65 A Weather-Ometer. The intensity is 0.75 W/(nm*m²) at a wavelength of 340 nm and one drying/spraying cycle lasts 102:18 minutes. The black panel temperature is 70±3° C. and the air humidity during the drying cycle is 40±3%. The inner and outer filters are Boro filters. In terms of the invention, the protective layer should have a sufficiently high weathering resistance. This criterion is achieved in terms of the invention when the sample is exposed to at least 5000 hours of the weathering described above without exhibiting haze, cracking or delamination.

### g) Measurement of the Migration of the UV Absorber

Coated and cured sheets were immersed in boiling water (1 hour) to accelerate migration. Migration to the surface was detected visually as the formation of a white film on the surface which can be wiped off with a soft cloth.

### h) Measurement of the Pencil Hardness

The pencil hardness was measured analogously to ISO 15184 or ASTM D 3363.

The pencil was prepared by being drawn across a sheet of abrasive paper (no. 400) at an angle of 90° to give a sharp-edged, flat surface. The sample to be measured must lie on an even horizontal base. The pencil was clamped in a carriage under a load of 0.75 kg (±10 g); this was placed on the surface to be tested and immediately pushed at least 7 mm over the surface. A damp cloth (moistened with e.g. isopropanol) was used to remove the graphite pencil marks from the surface, which was then inspected for damage.

The hardness of the hardest pencil which has not damaged the surface is the so-called pencil hardness:

Hardness scale according to ISO 15184 (1998 E) from soft to hard:

### 9B-8B-7B-6B-5B-4B-3B-2B-B-HB-F-H-2H-3H-4H-5H-6H-7H-8H-9H

### EXEMPLARY EMBODIMENTS

The following components were used below:

Component A: Desmolux® U680H from Bayer MaterialScience AG, a urethane triacrylate containing 20% of 1,6-hexanediol diacrylate as reactive diluent

Component B: ORGANOSILICASOL™ MEK-ST from Nissan Chemical America Corporation. The form in which the silica nanoparticles are supplied is in methyl ethyl ketone, which is replaced with diacetone alcohol. The solids content of the final dispersion is ca. 30%. The diameter of the nanoparticles is 10-15 nm (measured by light scattering N4 analysis and BET analysis).

Component C:

Component C-1: UV absorber Tinuvin® 479 from Ciba Specialty Chemicals. This compound has the following formula:

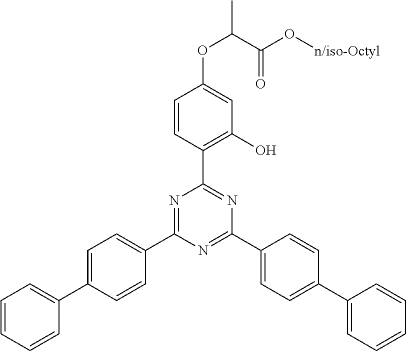

Component C-2: UV absorber of the following formula:

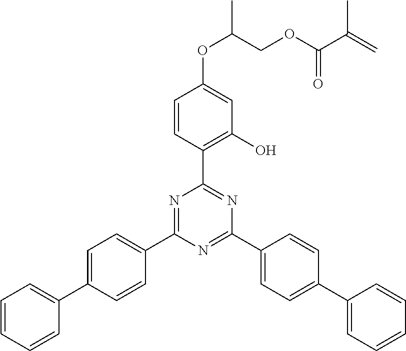 [SMILES: C=C(C)C(=O)OCC(C)Oc1ccc(-c2nc(-c3ccc(-c4ccccc4)cc3)nc(-c3ccc(-c4ccccc4)cc3)n2)c(O)c1]

Component C-3: UV absorber 2-(2′-hydroxy-5′-methacryloxyethylphenyl)-2H-benzotriazole available as Tinuvin® R796 from Ciba Specialty Chemicals. This compound has the following formula:

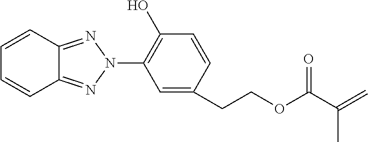 [SMILES: C=C(C)C(=O)OCCc1ccc(O)c(-n2nc3ccccc3n2)c1]

Component C-4: UV absorber 2-[4-[(2-hydroxy-3-(2′-ethyl)hexyl)oxy]-2-hydroxyphenyl]-4,6-bis(2,4-dimethylphenyl)-1,3,5-triazine available as Tinuvin® 405 from Ciba Specialty Chemicals. This compound has the following formula:

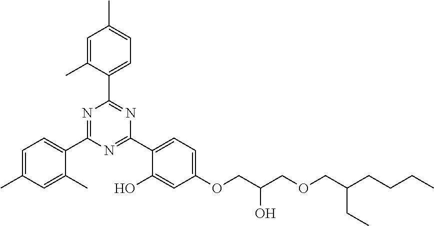 [SMILES: CCCCC(CC)COCC(O)COc1ccc(-c2nc(-c3ccc(C)cc3C)nc(-c3ccc(C)cc3C)n2)c(O)c1]

Component C-5: UV absorber of general formula (Ia) with the following groups:

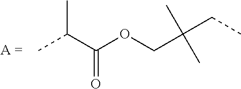

T is a urethane acrylate based on HDI (hexamethylene diisocyanate) isocyanurate, partially reacted with hydroxyethyl acrylate.

Q is —CH₂—CH₂— and R is hydrogen.

Component C-5 was prepared analogously to component C-6.

Component C-6: UV absorber of general formula (Ia) with the following groups:

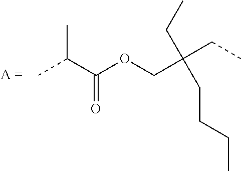

T is a urethane acrylate based on HDI (hexamethylene diisocyanate) isocyanurate, partially reacted with hydroxyethyl acrylate.

Q is —CH₂—CH₂— and R is hydrogen.

Synthesis of UV Absorber C-6:

899.9 g of Tinuvin® 479 (BASF), 1382.6 g of 2,2-dimethyl-1,3-propanediol and 65 g of dibutyltin oxide (Aldrich) were weighed out, combined and stirred for 5 h at 155° C. The octanol formed was then distilled off under a vacuum of 10 to 20 mbar. The reaction mixture was cooled and stirred into 5000 ml of methanol. The precipitate was filtered off and dried under vacuum. The solid was dissolved in 1400 ml of a toluene/ethyl acetate mixture (8:1). The solution was filtered through a layer (10 cm thick) of silica gel. The filtrate was concentrated by evaporation. The solid was suspended in methanol, filtered off and then dried under vacuum at 40° C. The intermediate has a melting point of 173° C.

2101.3 g of the resulting intermediate were dissolved in 3877.6 g of diacetone alcohol at 130° C. The solution was cooled to 80° C., passed through a T1000 filter (from Seitz) and added, with stirring, to Desmolux® D100 (5280.0 g) preheated to 90° C. The reaction mixture was stirred for a further 4 h at 90° C. and then cooled to 80° C. The NCO content was determined. The calculated amount of 862.0 g of 2-hydroxyethyl acrylate was then added to the reaction mixture and the reaction was allowed to continue for 8 h. The apparatus was then turned off and the product was cooled and pressed through a T5500 filter (from Seitz) into ready-prepared vessels.

Yield: 11,568 g

NCO content of the product: <0.1%; tin content: <1 mg/kg

Component D: HALS system bis(1,2,2,6,6-pentamethyl-4-piperidinyl) [[3,5-bis(1,1-dimethylethyl)-4-hydroxyphenyl]methyl]butylmalonate available as Tinuvin® 144 from Ciba Specialty Chemicals

Component E: levelling additive BYK® 300 from BYK Chemie

Component F: diacetone alcohol

Component G:

Component G-1: 1-hydroxycyclohexyl phenyl ketone available as Irgacure® 184 from Ciba Specialty Chemicals

Component G-2: ethyl 2,4,6-trimethylbenzoylphenylphosphinate available as Lucirin® TPO-L from BASF AG

### Results:

### Composition of the Formulation

TABLE A

| | | | wt %, data for |
|---|---|---|---|
| | | | all constituents |
| | | | apart from |
| Substance | Substance class | g | solvent |
| Diacetone | solvent | 50.0 | |
| alcohol | | | |
| Nissan | silica | 41.4 (12.4 g | 27.8 |
| Organosilicasol | nanoparticles | silica + | |
| MEK-ST | (30% solids in | 29 g DAA) | |
| | diacetone alcohol) | | |
| Desmolux | urethane tri- | 28.0 | 62.8 |
| U680H | acrylate (80% in | | |
| | 1,6-hexanediol | | |
| | diacrylate) | | |
| Lucirin TPO-L | photoinitiator | 0.28 | 0.6 |
| Irgacure 184 | photoinitiator | 1.12 | 2.5 |
| BYK 300 | leveling additive | 0.60 | 1.3 |
| Component C-1 | UV absorber | 1.8 | 4.1 |
| to C-4 | | | |
| Component C-5 | | 1.8 based on | 4.1 |
| and C-6 | | triazine content | |
| | | (without urethane | |
| | | side chain), 8.2 | |
| | | (with urethane | |
| | | side chain) | |
| Tinuvin ® 144 | HALS (free | 0.36 | 0.8 |
| | radical | | |
| | scavenger) | | |

### Example 1 (EX1)

Component C: compound C-2 described above was used as component C.

### Example 2 (EX2)

Component C: compound C-5 described above was used as component C.

### Example 3 (EX3)

Component C: compound C-6 described above was used as component C.

### Comparative Example (CE1)

Component C: Tinuvin® 479 from Ciba Specialty Chemicals

### Comparative Example (CE2)

Component C: Tinuvin® R796 from Ciba Specialty Chemicals

### Comparative Example (CE3)

Component C: Tinuvin® 405 from Ciba Specialty Chemicals

### Results of the Taber Test:

TABLE B

| | Number of Taber cycles | ΔHaze/% |
|---|---|---|
| EX 1 | 1000 | 3.4 |
| EX 2 | 1000 | 5.9 |
| EX 3 | 1000 | 6.0 |
| CE 1 | 1000 | 4.5 |
| CE 2 | 1000 | 6.0 |
| CE 3 | 1000 | 6.7 |

Apart from CE3, the coating compositions exhibit a good abrasion resistance.

### Results of Chemical Resistance to Acetone:

TABLE C

| | 1 min | 5 min | 15 min | 30 min |
|---|---|---|---|---|
| EX 1 | + | + | + | + |
| EX 2 | + | + | + | + |
| EX 3 | + | + | + | + |
| CE 1 | + | + | − | − |
| CE 2 | + | + | + | + |
| CE 3 | + | + | + | + |

Apart from CE1, the coating compositions exhibit a good chemical resistance.

### Results of Weathering:

The change in yellowness index (ΔYI) as a function of the weathering time. The yellowness index was measured with a layer thickness of 8 μm. The Comparative Examples exhibit a stronger yellowing and in some cases film formation during weathering, together with much earlier failure of the coating layer (appearance of delamination and cracking).

TABLE D

| | Time in hours | | | | | | |
|---|---|---|---|---|---|---|---|
| ΔYI | 0 | 1000 | 2000 | 3000 | 4000 | 5000 | 6000 |
| EX1 (8 μm) | 0 | −0.41^{#} | 1.13^{#} | 0.68^{#} | 0.82^{#} | 2.28^{#} | 3.10° |
| EX2 (8 μm) | 0 | −0.69^{#} | 0.82^{#} | 1.78^{#} | 1.96^{#} | 1.98^{#} | 2.34^{#} |
| EX3 (8 μm) | 0 | −1.09^{#} | 1.12^{#} | 0.80^{#} | 0.1^{#} | 1.05^{#} | 2.34^{#} |
| CE1 (8 μm) | 0 | — | 1.06* | 1.56* | 2.07* | 2.91* | 4.64*^{§} |
| CE2 (8 μm) | 0 | −0.43^{#} | 1.68^{#} | 2.87^{#} | 8.56° | | |
| CE3 (8 μm) | 0 | −0.47^{#} | 1.26^{#} | 2.83^{#} | 5.17°^{§} | | |

^{#}optically fully transparent (haze <3%)
*hazy spots form on the surface during weathering
^{§}delamination of the film
°first cracks are visible on the coating surface

After only 2000 h of weathering, Comparative Example CE1 exhibits hazy spots on the surface which continue to appear as weathering progresses. Comparative Examples CE2 and CE3 fail (i.e. delamination or cracking occurs) after only 4000 h of weathering. The yellowness index likewise rises sharply and ΔYI reaches unacceptable values of more than 4 after 4000 h.

Only Examples EX1, EX2 and EX3 according to the invention are stable over the long period of 6000 h (no cracks, no delamination); also, the yellowness index increases by less than 4.

Results of Migration Behaviour:

TABLE E

| | Visible haze caused by film |
|---|---|
| | formation on the surface? |
| EX 1 | No |
| EX 2 | No |
| EX 3 | No |
| CE 1 | Yes |
| CE 2 | No |
| CE 3 | Yes |

The Examples according to the invention exhibit a better migration behaviour.

### Influence of the UV Dose Used for Curing (Based on Example 1 of WO 2011/040541):

The compositions below were prepared by mixing and applied to PC sheets as described under a) and b). Curing with UV light was carried out as described under c), but with different UV doses between 0.27 J/cm² and 8.0 J/cm².

EX1: as defined above

CE1: as defined above

CE4: composition as described in Table F (comparable to Production Example 1 of WO 2011/040541).

TABLE F

| | | | wt %, data for |
|---|---|---|---|
| | | | all constituents |
| | Substance | | apart from |
| Substance | class | g | solvent |
| Diacetone | solvent | 83 | |
| alcohol | | | |
| PETA | pentaerythritol | 83 | 81.9 |
| | triacrylate as | | |
| | binder | | |
| Irgacure 127 | photoinitiator | 0.9 | 0.9 |
| Irgacure 907 | photoinitiator | 0.9 | 0.9 |
| Irgacure 184 | photoinitiator | 4.3 | 4.2 |
| BYK 300 | levelling additive | 0.1 | 0.001 |
| Tinuvin 479 | UV absorber | 12.2 | 12.0 |

Pencil hardnesses were measured for different compositions and different layer thicknesses. As can be seen in Table G, a UV dose below 2 J/cm² is not sufficient to fully cure the composition. The surface hardness, as measured by the pencil hardness, is very soft. Above a minimum dose of 2 J/cm² the formulation is fully cured and achieves pencil hardnesses of at least H. Such good pencil hardnesses of H can only be achieved at all with the formulation according to the invention.

TABLE G

| | UV dose | Layer thickness | |
|---|---|---|---|
| | J/cm² | μm | Pencil hardness |
| EX1 | 0.27 | 10 | 3B |
| EX1 | 0.5 | 10 | 3B |
| EX1 | 1.0 | 10 | F |
| EX1 | 2.0 | 10 | H |
| EX1 | 6.0 | 9 | H |
| CE1 | 0.27 | 9 | 2B |
| CE1 | 0.5 | 10 | 3B |
| CE1 | 1.0 | 9 | 2B |
| CE1 | 2.0 | 9 | F |
| CE1 | 4.0 | 9 | F |
| CE1 | 8.0 | 9 | F |
| CE4 | 0.27 | 10 | softer than 4B |
| CE4 | 0.5 | 11 | 3B |
| CE4 | 1.0 | 11 | 3B |
| CE4 | 4.0 | 12 | F |

1.-16. (canceled)

17. A coating composition comprising:
A) one or more aliphatic polymer precursors selected from components A.1 and optionally A.2:
A.1) aliphatic oligomers containing urethane or ester bonds and having at least two acrylate functions per molecule, or mixtures of said oligomers, and
A.2) aliphatic reactive diluents having at least two acrylate groups per molecule, or mixtures of said reactive diluents,
B) optionally one or more finely divided inorganic compounds,
C) an organic UV absorber,
D) a non-incorporable free radical scavenger from the HALS class,
E) optionally one or more levelling additives,
F) optionally one or more solvents, and
G) a photoinitiator,
the organic UV absorber C) being an absorber of general formula (Ia): 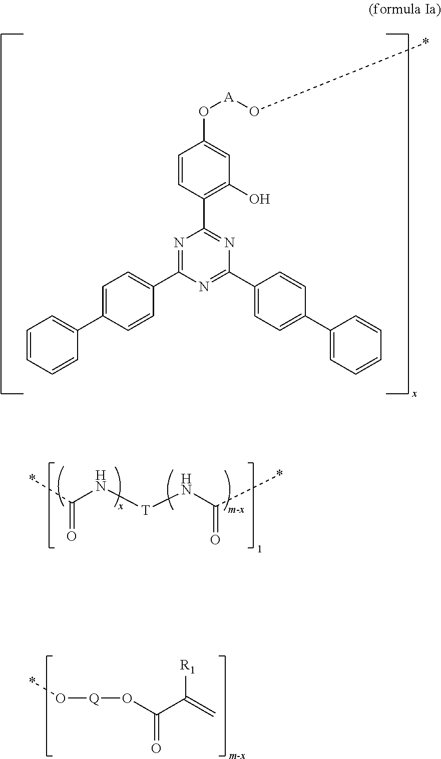
where
R₁ is hydrogen or a methyl radical,
Q is a linear or branched alkylene having preferably 1 to 10 . . . .
T is a nucleus of the aliphatic and cycloaliphatic polyisocyanates T(NCO)ₘ which have cyclic isocyanurate, uretdione, iminooxadiazinedione or oxadiazinetrione structures, as well as branched biuret structures in the case of cycloaliphatic polyisocyanates,
m corresponds to the original average NCO functionality of the polyisocyanate used and is equal to or greater than 2,
A is an optionally substituted, linear or branched alkylene having preferably 1 to 20 carbon atoms, it being possible for the carbon chain to be interrupted by oxygen, carboxyl, nitrogen, sulfur, phosphorus and/or silicon,
and
x represents the average molar proportion of the bound UV absorber radical and is less than m, or the organic UV absorber C) being an absorber of general formula (Ib):
A-X—O—C(═O)—C(R)═CH₂ (Ib)
where
A is: 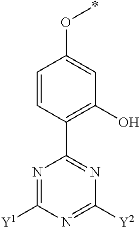
Y¹ and Y² independently of one another are substituents of the general formula 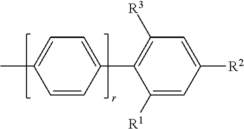
r is 0 or 1, preferably 1,
R¹, R², R³ independently of one another are H, OH, C₁₋₂₀-alkyl, C₄₋₁₂-cycloalkyl, C₂₋₂₀-alkenyl, C₁₋₂₀-alkoxy, C₄₋₁₂-cycloalkoxy, C₂₋₂₀-alkenyloxy, C₇₋₂₀-aralkyl, halogen, —C≡N, C₁₋₅-halogenoalkyl, —SO₂R′, —SO₃H, —SO₃M (M=alkali metal), —COOR′, —CONHR′, —CONR′R″, —OCOOR′, —OCOR′, —OCONHR′, (meth)acrylamino, (meth)acryloxy, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
M is an alkali metal cation,
R′ and R″ are H, C₁₋₂₀-alkyl, C₄₋₁₂-cycloalkyl, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
X is branched or unbranched C₁₋₂₀-alkyl, and
R is H or CH₃.

18. The coating composition according to claim 17, wherein X in formula (Ib) for the UV absorber C) is CH(CH₃) and T in formula (Ia) is an isocyanurate based on hexamethylene diisocyanate (HDI).

19. The coating composition according to claim 17, wherein r in the substituents Y¹ and Y² in formula (Ib) for the UV absorber C) is in each case 1 and Q in formula (la) is CH₂—CH₂.

20. The coating composition according to claim 17, wherein the radicals R¹, R² and R³ in the substituents Y¹ and Y² in formula (I) for the UV absorber C) are in each case H and A in formula (Ia) is C(CH₃)—CO—O—CH₂—CR⁴R⁵—CH₂, R⁴ and R⁵ independently of one another being alkyl having 1 to 6 carbon atoms.

21. The coating composition according to claim 17, wherein component A.1 comprises an unsaturated aliphatic urethane acrylate.

22. The Coating composition according to claim 17, wherein component C is a UV absorber of formula (Ia) with the following groups: 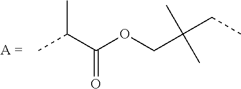
T is a urethane acrylate based on HDI (hexamethylene diisocyanate) isocyanurate, partially reacted with hydroxyethyl acrylate,
Q is —CH₂—CH₂— and
R is hydrogen,
or a UV absorber of formula (Ia) with the following groups: 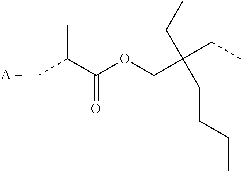
T is a urethane acrylate based on HDI (hexamethylene diisocyanate) isocyanurate, partially reacted with hydroxyethyl acrylate.
Q is —CH₂—CH₂— and
R is hydrogen.

23. The coating composition according to claim 17, wherein component C is a UV absorber of general formula (Ib):
A-X—O—C(═O)—C(R)═CH₂ (Ib)
where
A is: 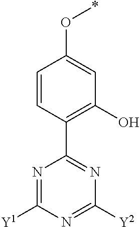
Y¹ and Y² independently of one another are substituents of the general formula 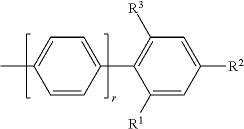
r is 0 or 1, preferably 1,
R¹, R², R³ independently of one another are H, OH, C₁₋₂₀-alkyl, C₄₋₁₂-cycloalkyl, C₂₋₂₀-alkenyl, C₁₋₂₀-alkoxy, C₄₋₁₂-cycloalkoxy, C₂₋₂₀-alkenyloxy, C₇₋₂₀-aralkyl, halogen, —C≡N, C₁₋₅-halogenoalkyl, —SO₂R′, —SO₃H, —SO₃M (M=alkali metal), —COOR′, —CONHR′, —CONR′R″, —OCOOR′, —OCOR′, —OCONHR′, (meth)acrylamino, (meth)acryloxy, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
M is an alkali metal cation,
R′ and R″ are H, C₁₋₂₀-alkyl, C₄₋₁₂-cycloalkyl, C₆₋₁₂-aryl optionally substituted by C₁₋₁₂-alkyl, C₁₋₁₂-alkoxy, CN and/or halogen, or C₃₋₁₂-heteroaryl optionally substituted by C₁₋₁₂-alkyl, C₁₋₁₂-alkoxy, CN and/or halogen,
X is branched or unbranched C₁₋₂₀-alkyl, and
R is H or CH₃.

24. The coating composition according to claim 17, comprising a non-incorporable free radical scavenger from the HALS class.

25. The coating composition according to claim 24, wherein the free radical scavenger from the HALS class is a piperidine derivative having the general structure of formula (IV): 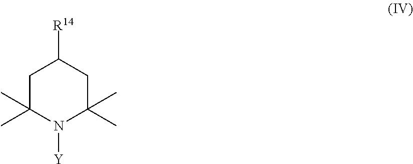
where
Y=H or CH₃,
R¹⁴=Z—R¹⁵—Z—R¹⁶, 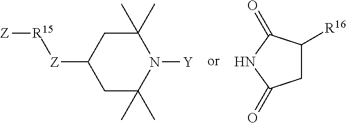
Z=a divalent functional group,
R¹⁵=a divalent organic radical,
and
R¹⁶ is H or C₁-C₂₀-alkyl.

26. A process for the coating of a substrate, comprising the following steps:
applying the coating composition according to claim 17 to a substrate;
curing of the applied coating composition by irradiation with UV light in a dose of at least 2 J/cm².

27. A coated substrate comprising a substrate and a coating arranged on or above the substrate, wherein the coating comprises a coating composition according to claim 17.

28. The coated substrate according to claim 27, wherein the substrate is a polycarbonate substrate, a polymethyl methacrylate substrate, a polystyrene substrate or a polyolefin substrate.

29. A coated substrate comprising a substrate and a coating arranged on or above the substrate, wherein the coating comprises a coating composition according to claim 17 which has been cured by irradiation with UV light in a dose of at least 2 J/cm², the UV dose being determined with a UV-4C SD measuring instrument from UV-Technik Meyer GmbH and the dose being the sum of the incident energy in the range 230-445 nm.

30. The coated substrate according to claim 29, wherein the substrate is a thermoplastic substrate.

31. The coated substrate according to claim 30, wherein the substrate is a polycarbonate substrate.

32. A product comprising a coated substrate according to claim 27, said product being selected from the group consisting of architectural glazing, automotive glazing, cover discs, helmet visors, housings for electrical appliances, window profiles, bodywork components and machine covers.
